(19) United States
(12) Patent Application Publication
(10) Pub. No.: US 2013/0323378 A1
(43) Pub. Date: Dec. 5, 2013

(54) REDUCTION OF WEIGHT LOSS OF FRUITS

(71) Applicants: Jacobus Stark, Echt (NL); Angelique De Rijk, Echt (NL)

(72) Inventors: Jacobus Stark, Echt (NL); Angelique De Rijk, Echt (NL)

(73) Assignee: DSM IP ASSETS B.V., Heerlen (NL)

(21) Appl. No.: 13/990,771

(22) PCT Filed: Jan. 12, 2012
(86) PCT No.: PCT/EP12/50429

§ 371 Date: Aug. 14, 2013

(30) Foreign Application Priority Data
Jan. 12, 2011 (EP) 11150718.2

(51) Int. Cl. A23B 7/154; A01N 43/90

(52) U.S. Cl. CPC A23B 7/154; A01N 43/90
USPC 426/308; 426/532; 536/6.5; 514/31; 504/187

(57) ABSTRACT

The present invention relates to the use of polyene fungicides for reducing weight loss of crops.

### FIELD OF THE INVENTION

The present invention discloses an antimicrobial composition to prevent weight loss of crops such as fruits, e.g. pineapples.

### BACKGROUND OF THE INVENTION

Pineapple is one of the most popular tropical fruits in the world. It contributes to over 20% of the world production of tropical fruits. It has been cultivated in South America since the 15^{th} century. However, it was not until the beginning of the 20^{th} century that advanced canning technology made it possible to deliver pineapples to people all over the world.

People now enjoy pineapples either as green, ripened or off-green fruits or in processed form. A large part of the pineapples is consumed as fresh fruit in producing countries, but a considerable amount of pineapples is also exported.

Pineapple plants can be damaged by nematodes, bacteria, viruses and fungi. The most serious plant disease problem is wilt disease vectored by mealybugs. Other diseases include pink disease, fusariosis disease, bacterial heart and root rot, yellow spot and anthracnose.

Besides pineapple plant diseases, spoilage of pineapples by fungi after harvesting is an issue of major concern. After cutting the pineapples from the plant, fungi may develop on or in the pineapple at the peduncle (the wound), on the fruit rind or on the crown. At the peduncle, fungi may easily enter the wound. Later during transport and/or ripening spores can germinate and grow further into the pineapples leading to spoilage and economic losses. Also when fungi develop on the fruit rind or on the crown, the pineapples lose value or even have to be destroyed.

Different fungal pathogens are commonly found on post-harvest pineapples. Examples of frequently isolated spoilage fungi are Aspergillus niger, Fusarium oxysporum, Penicillium funiculosum, Rhizophus stolonifer, Thielaviopsis paradoxa and Ceratocystis paradoxa. As indicated above, the fungus can enter the fruit through wounds that originate from harvesting or grow on the fruit rind or crown. Natural growth cracks, shell bruises and wounds resulting from post-harvest handling may also provide entry points.

In spite of extensive treatment with the fungicides presently applied such as benomyl, captafol and triadimefon (see Cho et al. (1977); Bolkan et al. (1978); Pires de Matos (1995)), fungal spoilage problems still occur. It is known that fungi rather easily develop resistance to antifungal compounds, which is also the case for fungi causing spoilage of pineapples. Furthermore, many of the fungicides applied on pineapples cause environmental pollution and human health problems. Moreover, it is known that during storage and/or transport the respiration process of pineapples and excessive ventilation may cause weight losses of 8-10% which leads to economic losses.

Consequently, it can be concluded that there is a severe need for antimicrobial compositions that reduce weight loss of pineapples and other fruits and that are at the same time effective against fungi and environmental friendly.

### DESCRIPTION OF THE INVENTION

Unexpectedly, the present inventors have found that weight loss of crops, such as fruits, vegetables, grains, and beans after harvesting is reduced when a polyene fungicide is applied to the crops. The present invention provides a polyene fungicide and a process for the treatment of crops by applying the polyene fungicide to the crops. The application of the polyene fungicide leads to a reduced weight loss of the crops during storage. In other words crops treated with the polyene fungicide show less weight loss than untreated crops or crops treated with commonly used fungicides, e.g. triadimefon. In a preferred embodiment the crop is a fruit such as a pineapple or a banana.

In an aspect the present invention relates to the use of a polyene fungicide for reducing weight loss of crops such as fruits, vegetables, cereal crops and beans. The crop may be any crop that loses weight after harvesting, for instance during ripening, storage, transport and/or sale. In a preferred embodiment the crop is a fruit.

Examples of fruits are tropical fruits such as papayas, passion fruit, mangos, carambolas, pineapples, bananas, plantains, and kiwis; pome and stone fruits and berries such as apples, pears, plums, apricots, peaches, almonds, cherries, strawberries, grapes, raspberries and blackberries; and citrus fruits such as oranges, mandarins, clementines, tangerines, limes, pomelos, kumquats, grapefruits and lemons. Preferred fruits are pineapples, bananas, citrus fruits, pome and stone fruits, and berries. The polyene fungicide may be applied on any pineapple variety including the varieties Smooth Cayenne, Queen, and Red Spanish.

Examples of cereal crops are wheat; barley; rye; oats; rice; sorghum; and maize.

Examples of beans are coffee beans; cocoa beans; soy beans; lentils; and peas.

Examples of vegetables are cucumbers; pumpkins; gherkins; melons; squashes; aubergines; tomatoes; spinach; lettuce; sugar snaps; haricots verts; zucchini; endive; asparagus; cabbages; turnips; carrots; onions; garlic; leek; potatoes; seed-potatoes; hot and sweet peppers; and avocados.

Furthermore, by applying the polyene fungicide to the crop fungal growth on or in the crop can be prevented. In other words, the polyene fungicide can be used to protect crops such as pineapples from fungal growth and/or from fungal infection and/or from fungal spoilage.

The polyene fungicide is advantageously applied to crops after harvesting. In an embodiment the polyene fungicide is applied to a wound resulting from harvesting of the crop and/or onto the surface of the crop, e.g. on the crop rind. In general, the wound occurs when the crop is removed from a plant, e.g. a plant it is grown on. For instance, pineapples or bananas cut from the plant have a wound that is the consequence of the cutting. Cutting can be done with a knife, a chopper, a hatchet or the like. It can be done by hand or automatically. So, in general the harvested crop, e.g. pineapple or banana, is connected to its plant by a stalk which will be broken by mechanical force.

In an embodiment the polyene fungicide is applied before packaging and transport, e.g. shipping, of the crops. In a more preferred embodiment the polyene fungicide is applied within 15 minutes to 72 hours, preferably 30 minutes to 48 hours, more preferably 45 minutes to 24 hours, even more preferably 1 to 12 hours and in particular 1 to 6 hours after harvesting.

Suitable examples of polyene fungicides are natamycin, nystatin, amphotericin B, filipin, trienin, etruscomycin, chainin, dermostatin, lymphosarcin, candicidin, aureofungin A, aureofungin B, hamycin A, hamycin B and lucensomycin, to name just a few. The preferred polyene fungicide is natamycin. In an embodiment two or more different polyene fungicides may be applied. The may be applied simultaneously, e.g. in one composition, or separately in any order. It is to be understood that derivatives of polyene fungicides including, but not limited to, salts or solvates of polyene fungicides or modified forms of polyene fungicides may also be applied in the compositions of the invention. An example of a commercial product containing natamycin is the product with the brand name Delvocid® Instant. Delvocid® Instant is produced by DSM Food Specialties (The Netherlands) and contains 50% (w/w) natamycin. Another example is Delvocid® L, a liquid natamycin composition comprising 1-10% natamycin. Another example is Delvocid® +. Said commercial products can be incorporated in the compositions of the invention.

In an embodiment the polyene fungicide is applied to the crops as an antimicrobial, e.g. antifungal, composition. When the polyene fungicide is applied to the crops in the form of an antimicrobial composition, said composition comprises 0.1 g or less lignosulphonate, more preferably 0.1 g or less polyphenol, per gram polyene fungicide. Preferably, it comprises 0.01 g or less lignosulphonate, more preferably 0.01 g or less polyphenol, per gram polyene fungicide. In particular, it is free of lignosulphonate and preferably free of polyphenol.

In another embodiment the polyene fungicide is combined with a compound that stimulates the natural defense system of the plant or crop. An example of such a compound is a natural crop protection compound belonging to the group of phosphites, e.g. KH₂PO₃ or K₂HPO₃ or a mixture of both phosphite salts, and the combination is applied on the plants and/or crops. The combination can be applied simultaneously, e.g. in one antimicrobial composition, or separately in any order. Alternatively, the natural crop protection compound belonging to the group of phosphites can be applied to the plants and/or crops, i.e. pre-harvest, and the polyene fungicide can be applied to the crop, i.e. post-harvest.

Phosphite containing compounds as used herein means compounds comprising a phosphite group, i.e. PO₃ (in the form of e.g. H₂PO₃⁻, HPO₃²⁻ or PO₃³⁻) and includes compounds such as phosphorous acid and its (alkali metal or alkaline earth metal) salts such as potassium phosphites e.g. KH₂PO₃ and K₂HPO₃, sodium phosphites and ammonium phosphites; (C₁-C₄) alkyl esters of phosphorous acid and their salts such as aluminum ethyl phosphite (fosetyl-Al), calcium ethyl phosphite, magnesium isopropyl phosphite, magnesium isobutyl phosphite, magnesium sec-butyl phosphite and aluminum N-butyl phosphite; and phosphonic acid and derivatives thereof such as esters and/or alkali metal or alkaline earth metal salts thereof. Of course, mixtures of phosphite containing compounds are also encompassed. A mixture of e.g. KH₂PO₃ and K₂HPO₃ can easily be obtained by e.g. adding KOH or K₂CO₃ to a final pH of 5.0-6.0 to a KH₂PO₃ solution. As indicated above, precursor-type compounds which in the crop or plant are metabolized into phosphite compounds are also included within the meaning of the term phosphite containing compounds. Examples are phosphonates such as the fosetyl-aluminium complex. In e.g. a crop or plant the ethyl phosphonate part of this molecule is metabolized into a phosphite. An example of such a compound in the commercial ethyl hydrogen phosphonate product called Aliette® (Bayer, Germany).

The antimicrobial composition may have a pH of from 2 to 10, preferably of from 3 to 8, more preferably of from 4 to 7. It may be solid, e.g. a powder composition, or it may be liquid. Advantageously, it is a liquid which can be applied by dipping, spraying, showering, e.g. by using a cascade, fogging, or electrostatic spraying of the crops, e.g. pineapples. Alternatively, wounds on the crops, e.g. bananas or comparable fruits, can also be treated using a paintbrush or e.g. a pad of cotton wool or cellulose pads impregnated with a polyene fungicide. The polyene fungicide can also be applied by using plaster-like carriers which are placed on the wound. Moreover, resin-like or wax-like compositions known in the art which cover the wound surface can be applied.

Pineapples may be treated with a wax. Preferably, the polyene fungicide is applied together with the wax treatment. For the fruit rind preferably a cascade or shower is used, while for the treatment of the peduncle preferably a sprayer or brush is used.

In another aspect of this invention the polyene fungicide may be applied by means of a fruit coating, i.e. the coating comprises a polyene fungicide. The fruit coating may comprise compounds such as xanthan gum, sugars, glycerides and/or propylene glycol.

For all these treatments, methods and equipment well-known to a person skilled in the art can be used. In general, for pineapples a cascade or shower is used for treatment of the fruit rind and a sprayer or brush is used for treatment of the peduncle. For bananas, spraying applications using automatic systems are being used.

In an embodiment the polyene fungicide is applied after harvesting, in the case of pineapples, preferably directly after harvest and prior to packaging and transport. In addition, the crops, e.g. the pineapples, can be washed either prior to, simultaneously with or after the treatment with a polyene fungicide. Furthermore, if desired, the crops may be treated with other antimicrobial compositions either prior to, simultaneously with or after the treatment with the polyene fungicide.

After treatment with a polyene fungicide, the crops, e.g. pineapples, are packaged in corrugated board cartons, crates or fruit crates. Since pineapples can rapidly develop “pressure sores” under their own considerable weight, they are not generally packaged on their sides, but rather upright in telescope cartons. These telescope cartons, which are perforated at the top and sides, each contain for example two inserts each with six cells to carry a total of 12 pieces of fruit. The inserts are easily removed and make good presentation boxes for the retail trade. Each individual fruit may be protected against impact by wood wool. The packaging must additionally allow sufficient ventilation of the pineapples, since stagnant air around the pineapples encourages mold growth. This is ensured by perforations in the sides and the top and bottom of the described cartons. Another packaging type is compartment packaging, a packaging type wherein the carton is subdivided into rectangular compartments tailored to the particular dimensions of the different varieties and the bottom is lined with a 10 cm thick layer of plastic for accommodating the ends of the pineapples in order to prevent pressure sores. A rectangular collar is fitted between the shoulder and the lower end of the crown and fixes the pineapple securely in its compartment. Yet another packaging type is open packaging. This type of packaging lacks the compartments, the fruit being separated by padded battens. The bottom is again padded with a layer of plastic.

After harvest and packaging, the crops are stored or directly transported. Transportation may be done by ship, aircraft, truck, or railroad and may be done in refrigerated containers (e.g. 5-15° C., preferably 7-13° C.) with fresh air supply or controlled atmosphere, temperature, humidity/moisture (relative humidity of 85-90%) and ventilation conditions (air exchange rate 40-60 times per hour with constant supply of fresh air, so as constantly to remove the ripening gases arising and to keep the CO₂ content of the hold air low; spoilage may occur as a result both of inadequate ventilation (danger of rotting) and of excessive ventilation (drying-out, weight loss)). Because of its considerable impact- and pressure-sensitivity, packages comprising the crops must be secured in such a way that they are prevented from damaging each other.

In case the polyene fungicide is applied in the form of a composition, said composition will comprise 0.01 g/l to 100 g/l, preferably 0.03 g/l to 50 g/l of polyene fungicide. Most preferably, the amount is from 0.05 g/l to 5 g/l. Preferably, the polyene fungicide is natamycin. In case phosphite comprising compounds are present in the compositions, then the composition will generally comprise 0.1 g/l to 1000 g/l and preferably 0.2 g/l to 500 g/l potassium phosphite. More preferably, the amount of potassium phosphite is from 0.5 g/l to 30 g/l. According to the present invention also other phosphites may be used in equimolar amounts to the potassium phosphite. The crops are thus treated with polyene fungicide in a final concentration of 10 to 100,000 ppm, preferably 30 to 50,000 ppm and in particular 50 to 5000 ppm.

In addition, at least one additional antimicrobial compound may be applied to the crops. The other antimicrobial compound may be added simultaneously, e.g. in one antimicrobial composition, with the polyene fungicide or may be added separately in any order. Examples of antimicrobial compounds include antifungal compounds such as benomyl, captan, captafol, imazalil, triadimenol and triadimefon or any other antifungal compound suitable for treating crops such as e.g. pineapples or comparable fruits; compounds against insects, nematodes, mites and bacteria.

The antimicrobial composition may further comprise at least a suitable carrier and/or adjuvant ordinarily employed in formulation technology. The additional compound can be selected from the group consisting of a surfactant, a sticking agent, a thickening agent, a detergent, a preservative, a spreading agent, a filler, a flow additive, a spray oil, a mineral substance, a solvent, a dispersant, an emulsifier, a wetting agent, a stabiliser, an antifoaming agent, a buffering agent, a wax and an antioxidant.

In a preferred embodiment the additional compound is a wax. Of course, two or more different types of waxes can be used. Preferably, the wax is a synthetic wax. In case two or more different waxes are used, at least one of the waxes is a synthetic wax. Examples of synthetic waxes are sorbitan waxes with sorbitan ester waxes and ethoxylated sorbitan ester waxes being preferred. Examples of ethoxylated sorbitan ester waxes are Sta-Fresh 2981 and Decco Lustr 444. An example of a sorbitan ester wax is Sta-Fresh 2952. In an embodiment the sorbitan ester waxes and ethoxylated sorbitan ester waxes comprise from 0.1 to 90% (w/w), preferably from 0.5 to 75% (w/w), more preferably from 1 and 50% (w/w) and most preferably from 2 to 50% (w/w) of sorbitan ester and ethoxylated sorbitan ester, respectively.

Therefore, the present invention also provides an antimicrobial composition comprising a polyene fungicide and a wax, wherein the wax is a synthetic wax. Preferably, the wax is a sorbitan wax with a sorbitan ester wax and an ethoxylated sorbitan ester wax being preferred. Examples of ethoxylated sorbitan ester waxes and sorbitan ester waxes are given above. A sorbitan wax as used herein means a wax comprising a sorbitan compound. A sorbitan ester wax as used herein means a wax comprising a sorbitan ester compound. An ethoxylated sorbitan ester wax as used herein means a wax comprising an ethoxylated sorbitan ester compound. The waxes may of course also comprise additional constituents. Examples thereof are vegetable oils, triglycerides, glycerol, propylene glycol.

In an embodiment the amount of wax in the composition is between 0.05% (w/w) and 90% (w/w), preferably between 0.1% (w/w) and 70% (w/w), more preferably between 0.2% (w/w) and 50% (w/w), most preferably between 0.3% (w/w) and 25% (w/w). As indicated above, the composition will comprise 0.01 g/l to 100 g/l, preferably 0.03 g/l to 50 g/l of polyene fungicide. Most preferably, the amount is from 0.05 g/l to 5 g/l. Preferably, the polyene fungicide is natamycin.

The present invention also provides a method for the treatment of a pineapple, the method comprising the step of applying an antimicrobial composition according to the invention to the pineapple. Preferably, the antimicrobial composition according to the invention comprises a polyene fungicide and a wax, wherein the wax is a synthetic wax. Preferably, the wax is a sorbitan wax with a sorbitan ester wax and an ethoxylated sorbitan ester wax being preferred. Examples of ethoxylated sorbitan ester waxes and sorbitan ester waxes are given above.

In an embodiment of the method for the treatment of a pineapple the pineapple is treated after harvesting.

In an embodiment of the method for the treatment of a pineapple the pineapple and/or the pineapple plant is treated with a phosphite containing compound before the pineapple is harvested. In other words, a phosphite containing compound is applied to the pineapple and/or pineapple plant pre-harvest, i.e. when the pineapple and/or pineapple plant is planted, grown and/or cultivated.

In an embodiment of the method for the treatment of a pineapple the harvested pineapple is placed on a moving conveyor belt, and the antimicrobial composition is applied to the pineapple rind by means of a shower, a cascade or by means of immersion of the pineapple.

As already indicated above, the antimicrobial composition is applied after harvesting, in the case of pineapples, preferably directly after harvest and prior to packaging and transport. In addition, the pineapples can be washed either prior to, simultaneously with or after the treatment with the antimicrobial composition. Preferably, the pineapples are washed before the antimicrobial composition is applied to the pineapple rind.

Furthermore, if desired, the pineapples may be treated with other antimicrobial compositions either prior to, simultaneously with or after the treatment with the natamycin comprising antimicrobial composition.

After treatment with the antimicrobial composition the pineapples are packaged in corrugated board cartons, crates or fruit crates. Since pineapples can rapidly develop “pressure sores” under their own considerable weight, they are not generally packaged on their sides, but rather upright in telescope cartons. These telescope cartons, which are perforated at the top and sides, each contain for example two inserts each with six cells to carry a total of 12 pieces of fruit. The inserts are easily removed and make good presentation boxes for the retail trade. Each individual fruit may be protected against impact by wood wool. The packaging must additionally allow sufficient ventilation of the pineapples, since stagnant air around the pineapples encourages mold growth. This is ensured by perforations in the sides and the top and bottom of the described cartons. Another packaging type is compartment packaging, a packaging type wherein the carton is subdivided into rectangular compartments tailored to the particular dimensions of the different varieties and the bottom is lined with a 10 cm thick layer of plastic for accommodating the ends of the pineapples in order to prevent pressure sores. A rectangular collar is fitted between the shoulder and the lower end of the crown and fixes the pineapple securely in its compartment. Yet another packaging type is open packaging. This type of packaging lacks the compartments, the fruit being separated by padded battens. The bottom is again padded with a layer of plastic.

After harvest and packaging, the pineapples are stored or directly transported. Transportation may be done by ship, aircraft, truck, or railroad and may be done in refrigerated containers (e.g. 5-15° C., preferably 7-13° C.) with fresh air supply or controlled atmosphere, temperature, humidity/moisture (relative humidity of 85-90%) and ventilation conditions (air exchange rate 40-60 times per hour with constant supply of fresh air, so as constantly to remove the ripening gases arising and to keep the CO₂ content of the hold air low; spoilage may occur as a result both of inadequate ventilation (danger of rotting) and of excessive ventilation (drying-out, weight loss)). Because of its considerable impact- and pressure-sensitivity, packages comprising the pineapples must be secured in such a way that they are prevented from damaging each other.

In an embodiment of the method for the treatment of a pineapple an antimicrobial composition is also applied to the peduncle of the harvested pineapple. Preferably, this is done by means of brushing or spraying. The antimicrobial composition applied to the peduncle may be identical to the antimicrobial composition applied to the pineapple rind, i.e. an antimicrobial composition comprising a polyene fungicide and a wax, wherein the wax is a synthetic wax, preferably a sorbitan wax such as a sorbitan ester wax or an ethoxylated sorbitan ester wax. However, the antimicrobial composition applied to the peduncle may also be different from the antimicrobial composition applied to the rind (e.g. in that it comprises at least a different antimicrobial compound, at least a different wax, or no wax at all).

The present invention also provides a pineapple comprising the antimicrobial composition according to the invention. Preferably, the antimicrobial composition comprises a polyene fungicide and a wax, wherein the wax is a synthetic wax. Preferably, the wax is a sorbitan wax with a sorbitan ester wax and an ethoxylated sorbitan ester wax being preferred. Examples of ethoxylated sorbitan ester waxes and sorbitan ester waxes are given above. The pineapple comprises the antimicrobial composition on its rind and/or on its peduncle. In an embodiment the pineapple is of the variety Sugarloaf, Cayenne, Queen, Red Spanish, Golden Pineapple, Cherimoya, Smooth Cayenne, Kew, Mauritius, Jaldhup, Lakhat, Queenstand, Tyhone, Sarawak, Espanola, Permambuco, G-25, MD-2, or Variegated, to name just a few.

### EXAMPLES

### Example 1

### Treatment of Pineapples

Freshly harvested pineapples from the company Pina Tica Rio Cuarto S.A. (Grecia, Alajuela, Costa Rica) were used. The experiments were done within 24 hours after harvesting. The pineapples were selected in order to present uniform color and weight. The selected fruits were free of pathological and entomological problems as well as other physiological problems.

The surface of the pineapples was first disinfected by immersion of the fruits for one minute in a solution comprising 150 ppm sodium hypochlorite. Next, the fruits were dried and thereafter the following antimicrobial compositions were applied on the fruits using a modified simulated shower wax cascade similar to that used in pineapple packing plants. This shower covered the fruits with a thin film of wax (without product on the crown).
Composition A: aqueous composition comprising 500 ppm of triadimefon (Bayleton 25 WP) and 8% v/v wax (Decco Lustr 444);
Composition B: aqueous composition comprising 2000 ppm of natamycin and 8% v/v wax (Decco Lustr 444);
Composition C: aqueous composition comprising 500 ppm of natamycin, 4400 ppm potassium phosphite and 8% v/v wax (Decco Lustr 444);
Composition D (control): aqueous composition comprising 8% v/v wax (Decco Lustr 444). All compositions had a pH of 5.5.

In addition, an aqueous antimicrobial solution at a rate of 1 ml per fruit was applied to the peduncle (the wound) of each of the treated fruits. The concentration of the antifungal compound in the aqueous antimicrobial solution was identical to the concentration of the antifungal compound in the wax composition.

Fungal spore suspensions containing 10⁶ spores per ml of the following fungi: Aspergillus niger, Fusarium oxysporum, Penicillium funiculosum, Rhizopus stolonifer and Thielaviopsis paradoxa were prepared using well-known methods. After application of the compositions, the pineapples were dried and inoculated with the respective aqueous fungal spore suspensions. Inoculation was done by applying 1 ml of a spore suspension directly to the peduncle and by distributing 4 ml of the spore suspension over the complete surface of the fruit rind.

The experiment was done in eighteen fold (eighteen pineapples per fungal species). As a control, pineapples that were not inoculated with fungal species were included.

Next, the pineapples were stored in a cold chamber at a temperature of 7.5° C. for 14 days to simulate transport of the pineapples in a shipping container. After 14 days, the temperature was raised to 20° C. to simulate display on the supermarket shelf. The weight of the pineapples was determined after 7 days at 20° C. Total storage time was thus 21 days.

The results (see Table 1) clearly show that the weight loss of pineapples is much lower when the pineapples are treated with natamycin compared to when the pineapples are treated with triadimefon or treated with only wax. The results also clearly demonstrate that disinfected pineapples which are not inoculated with fungi have a higher weight loss than natamycin treated pineapples.

### Example 2

### Treatment of Pineapples

Freshly harvested pineapples from the company Pina Tica Rio Cuarto S.A. (Grecia, Alajuela, Costa Rica) were used. The experiments were done within 24 hours after harvesting. The pineapples were selected in order to present uniform color and weight. The selected fruits were free of pathological and entomological problems as well as other physiological problems.

The surface of the pineapples was first disinfected by immersion of the fruits for one minute in a solution comprising 150 ppm sodium hypochlorite. Next, the fruits were dried and thereafter the following antimicrobial compositions were applied on the fruits using a modified simulated shower wax cascade similar to that used in pineapple packing plants. This shower covered the rind of the fruits with a thin film of wax (without product on the crown).
Composition A: aqueous composition comprising 5% v/v wax (Sta-Fresh 2981);
Composition B: aqueous composition comprising 500 ppm of triadimefon (Bayleton 25 WP) and 5% v/v wax (Sta-Fresh 2981);
Composition C: aqueous composition comprising 500 ppm of natamycin and 5% v/v wax (Sta-Fresh 2981);
Composition D: aqueous composition comprising 5% v/v wax (Sta-Fresh 2952);
Composition E: aqueous composition comprising 500 ppm of triadimefon (Bayleton 25 WP) and 5% v/v wax (Sta-Fresh 2952);
Composition F: aqueous composition comprising 500 ppm of natamycin and 5% v/v wax (Sta-Fresh 2952);
Composition G: aqueous composition comprising 8% v/v wax (Decco Lustr 444);
Composition H: aqueous composition comprising 500 ppm of natamycin and 8% v/v wax (Decco Lustr 444). All compositions had a pH of 5.5.

In addition, the respective compositions were sprayed onto the peduncle (the wound) of each of the treated fruits at a rate of 1 ml per fruit.

After application of the compositions, the pineapples were dried.

The experiment was done in forty fold (5 boxes per composition, each box comprising 8 pineapples).

To simulate transportation of the pineapples in a shipping container, the pineapples were stored in a cold chamber at a temperature of 6-7° C. for 7 days. After 7 days, the temperature was raised to 16 to 20° C. to simulate shelf-life in a supermarket. The weight of the pineapples was determined after 7 days at 16 to 20° C. Total storage time was thus 14 days.

The results (see Table 2) clearly show that the weight loss of pineapples is lower when the pineapples are treated with natamycin compared to when the pineapples are treated with triadimefon or treated with only wax. This is demonstrated for several waxes.

### Example 3

### Treatment of Mandarins

Twenty fresh, untreated mandarins were used per treatment. The peel of each mandarin was wounded once using a cork borer according to the method described by de Lapeyre de Bellaire and Dubois (1987). Subsequently, each wound was inoculated with 10 μl of a Penicillium italicum suspension containing 1×10⁵ of spores/ml. After incubation for 2 hours at room temperature, the mandarins were dipped individually for 1 minute in a freshly prepared aqueous antimicrobial composition comprising 1000 ppm natamycin (Delvocoat L02101, DSM Food Specialties, Delft, The Netherlands) and 13.5% of a wax emulsion comprising 23.7% (w/w) beeswax and 5% (w/w) polyoxyethylene (20) sorbitan monostearate. In addition, the aqueous antimicrobial composition comprised 0.76% (w/w) glycerol, 0.03% (w/w) methylhydroxyethylcellulose (MHEC), 0.02% (w/w) xanthan gum, 0.41% (w/w) anti-foaming agent, 0.15% (w/w) citric acid and 0.01% (w/w) potassium sorbate. The pH of the composition was 4.0. As a control the composition without natamycin was used.

Thereafter, the mandarins (20 mandarins treated with the control composition and 20 mandarins treated with the antifungal composition) were placed on a sieved tray to dry for at least two hours and subsequently the mandarins were weighed individually (weight at t=0). The mandarins were stored for 7 days at 20° C. and each individual mandarin was weighed on day 3, day 5 and day 7 and the weight loss (in gram) of each individual mandarin (compared to the weight at t=0) was determined.

The results (see Table 3) clearly show that mandarins treated with the antimicrobial composition have a reduced weight loss at day 3, day 5 and day 7 compared to mandarins treated with the control composition at day 3, day 5 and day 7, respectively.

After 3 days of storage, six mandarins treated with the antimicrobial composition have a weight loss of >0 to ≦0.25 gram, while only one mandarin treated with the control composition has a weight loss of >0 to ≦0.25 gram. All other mandarins treated with the control composition have a higher weight loss (i.e. >0.25 to ≦0.50 gram).

After 5 days of storage, nine mandarins treated with the antifungal composition have a weight loss of >0.25 to ≦0.50 gram, while only one mandarin treated with the control composition has a weight loss of >0.25 to ≦0.50 gram. All other mandarins treated with the control composition have a higher weight loss (i.e. >0.50 to ≦1.00 gram).

After 7 days of storage, seven mandarins treated with the antifungal composition have a weight loss of >0.50 to ≦1.00 gram, while none of the mandarins treated with the control composition have a weight loss of >0.50 to ≦1.00 gram. All mandarins treated with the control composition have a higher weight loss (i.e. >1.00 gram).

Hence, the antimicrobial composition comprising natamycin is superior to the control composition in preventing mandarins from losing weight.

### Example 4

### Treatment of Strawberries

Twenty fresh, untreated strawberries were used per treatment and dipped individually for 1 minute in a freshly prepared aqueous antimicrobial composition comprising 1000 ppm natamycin (Delvocoat L 02101, DSM Food Specialties, Delft, The Netherlands), 1% (w/w) methylhydroxyethylcellulose (MHEC), 0.40% (w/w) xanthan gum, 0.20% (w/w) anti-foaming agent, 0.30% (w/w) citric acid, 0.39% (w/w) lactic acid and 0.11% (w/w) potassium sorbate. As a control the composition without natamycin was used.

Thereafter, the strawberries were placed on a sieved tray to dry for at least two hours and subsequently the strawberries were weighed individually (weight at t=0). The strawberries were stored for 2 days at 20° C. and each individual mandarin was weighed on day 1 and day 2 and the weight loss (in gram) of each individual strawberry (compared to the weight at t=0) was determined.

The results (see Table 4) clearly show that strawberries treated with the antimicrobial composition have a reduced weight loss at day 1 and day 2 compared to strawberries treated with the control composition at day 1 and day 2, respectively.

After 1 day of storage, fourteen strawberries treated with the antifungal composition have a weight loss of >0 to ≦0.10 gram, while only five strawberries treated with the control composition have a weight loss of >0 to ≦0.10 gram. All other strawberries treated with the control composition have a higher weight loss (i.e. >0.10 to ≦0.20 gram).

After 2 days of storage, fourteen strawberries treated with the antifungal composition have a weight loss of >0.10 to ≦0.20 gram, while only nine strawberries treated with the control composition have a weight loss of >0.10 to ≦0.20 gram. All other strawberries treated with the control composition have a higher weight loss (i.e. >0.20 gram).

Hence, the antimicrobial composition comprising natamycin protects strawberries much better against weight loss than the control composition without natamycin.

### Example 5

### Treatment of Pineapples

Ten untreated pineapples were used per treatment and covered with a thin layer of antifungal composition by submerging them individually in the composition for approximately 10 seconds. The antimicrobial compositions used were antimicrobial compositions comprising 500 ppm natamycin (Delvocid® Instant, DSM Food Specialties, Delft, The Netherlands) and one of the following waxes: 5% (v/v) Sta-Fresh 2981, 5% (v/v) Sta-Fresh 2952, or 8% (v/v) Decco Lustr 444. As a control the respective wax compositions without natamycin were used.

Thereafter, the pineapples were placed on a tray to dry for at least two hours and subsequently the pineapples were weighed individually (weight at t=0). The pineapples were stored for 9 days at 20° C. and each individual pineapple was weighed on day 2, day 5 and day 9 and the average weight loss (in gram) of the pineapples per treatment (compared to the weight at t=0) was determined.

The results in Table 5 clearly demonstrate that the weight loss after 2, 5 and 9 days of storage at 20° C. was lower when pineapples were treated with the antimicrobial compositions comprising natamycin and the waxes Sta-Fresh 2981, Sta-Fresh 2952 or Decco Lustr 444 than when pineapples were treated with compositions comprising only Sta-Fresh 2981, Sta-Fresh 2952 or Decco Lustr 444, respectively.

TABLE 1
Average weight loss of the pineapples
in grams and percentage after 21 days.

| | Weight loss | Weight loss |
|---|---|---|
| Composition | (in gram) | (in %) |
| Composition A (triadimefon) | 105.3 | 5.6 |
| Composition B (natamycin) | 87.4 | 4.7 |
| Composition C (natamycin + phosphite) | 88.9 | 4.9 |
| Composition D (control) | 111.1 | 5.9 |
| No fungal inoculation | 113.9 | 6.2 |

TABLE 2
Average weight loss of the pineapples in grams after 14 days.

| | Weight loss |
|---|---|
| Composition | (in gram) |
| Composition A (wax Sta-Fresh 2981) | 52 |
| Composition B (wax Sta-Fresh 2981 + triadimefon) | 55 |
| Composition C (wax Sta-Fresh 2981 + natamycin) | 49 |
| Composition D (wax Sta-Fresh 2952) | 45 |
| Composition E (wax Sta-Fresh 2952 + triadimefon) | 45 |
| Composition F (wax Sta-Fresh 2952 + natamycin) | 41 |
| Composition G (wax Decco Lustr 444) | 52 |
| Composition H (wax Decco Lustr 444 + natamycin) | 48 |

TABLE 3
Weight loss of mandarins after storage at 20° C.

| | | Number of mandarins with specific weight | | | |
|---|---|---|---|---|---|
| | | loss/total numbers of mandarins (20) | | | |
| | | Weight | Weight | Weight | |
| | Storage | loss >0 | loss >0.25 | loss >0.50 | Weight |
| | time | to ≦0.25 | to ≦0.50 | to ≦1.00 | loss >1.00 |
| Composition | (days) | gram | gram | gram | gram |
| Control | 3 | 1/20 | 19/20 | | |
| Natamycin | | 6/20 | 14/20 | | |
| Control | 5 | | 1/20 | 19/20 | |
| Natamycin | | | 9/20 | 11/20 | |
| Control | 7 | | | | 20/20 |
| Natamycin | | | | 7/20 | 13/20 |

TABLE 4
Weight loss of strawberries after storage at 20° C.

| | | Number of strawberries with specific weight | | |
|---|---|---|---|---|
| | | loss/total numbers of strawberries (20) | | |
| | | Weight | Weight | |
| | Storage | loss >0 | loss >0.10 | Weight |
| | time | to ≦0.10 | to ≦0.20 | loss >0.20 |
| Composition | (days) | gram | gram | gram |
| Control | 1 | 5/20 | 15/20 | |
| Natamycin | | 14/20 | 6/20 | |
| Control | | | 9/20 | 11/20 |
| Natamycin | 2 | | 14/20 | 6/20 |

TABLE 5
Average weight loss of the pineapples
in grams after storage at 20° C.

Average weight loss (in gram)
during storage time (in days)

| Composition | 2 days | 5 days | 9 days |
|---|---|---|---|
| Sta-Fresh 2981 | 16 | 39 | 63 |
| Sta-Fresh 2981 + natamycin | 10 | 22 | 29 |
| Sta-Fresh 2952 | 15 | 31 | 55 |
| Sta-Fresh 2952 + natamycin | 8 | 19 | 31 |
| Decco Lustr 444 | 12 | 38 | 69 |
| Decco Lustr 444 + natamycin | 9 | 24 | 35 |

### REFERENCES

Bolkan H. A., Dianese J. C. and Cupertino F. P. (1978), Chemical control of pineapple fruit rot caused by Fusarium monoliforme var. subglutinans. Plant Disease Reporter 62: 822-824
Cho J. J., Rohrbach K. G. and Apt W. J. (1977), Induction and chemical control of rot caused by Ceratocystis paradoxa on pineapples. Phytopathology 67: 700-703.
Pires de Matos A (1995), Pathological aspects of the pineapple crop with emphasis on the Fusariosis. Rev. Fac. Agron. (Maracay) 21:179-197.

1. A polyene fungicide capable of being used for reducing weight loss of a crop.

2. A polyene fungicide capable of being used according to claim 1, wherein said crop is a fruit.

3. A polyene fungicide capable of being used according to claim 2, wherein said fruit is a pineapple or a banana.

4. A polyene fungicide capable of being used according to claim 1, wherein said polyene fungicide is applied to said crop after harvesting.

5. A polyene fungicide capable of being used according to claim 1, wherein said polyene fungicide is applied to a surface of said crop.

6. A polyene fungicide capable of being used according to claim 5, wherein said polyene fungicide is applied to a wound resulting from harvesting of said crop.

7. A polyene fungicide capable of being used according to claim 1, wherein said polyene fungicide is natamycin.

8. A polyene fungicide capable of being used according to claim 7, wherein said polyene fungicide is applied as an antimicrobial composition.

9. A polyene fungicide capable of being used according to claim 8, wherein said antimicrobial composition further comprises a phosphite containing compound.

10. A polyene fungicide capable of being used according to claim 8, wherein said composition further comprises at least one additional compound selected from the group consisting of a surfactant, a sticking agent, an antimicrobial agent, a thickening agent, a detergent, a preservative, a spreading agent, a filler, a flow additive, a spray oil, a mineral substance, a solvent, a dispersant, an emulsifier, a wetting agent, a stabiliser, an antifoaming agent, a buffering agent, a wax and an antioxidant.

11. An antimicrobial composition comprising a polyene fungicide and a wax, wherein said wax is a synthetic wax.

12. The antimicrobial composition according to claim 11, wherein said wax is a sorbitan wax.

13. The antimicrobial composition according to claim 11, wherein said wax is a sorbitan ester wax or an ethoxylated sorbitan ester wax.

14. A method for treating a pineapple comprising applying an antimicrobial composition according to claim 11 to the pineapple.

15. The method according to claim 14, wherein said pineapple is treated after harvesting.

16. The method according to claim 14, wherein said pineapple and/or a pineapple plant is treated with a phosphite containing compound before said pineapple is harvested.

17. The method according to claim 15, wherein said harvested pineapple is:
a) placed on a moving conveyor belt, and
b) said antimicrobial composition is applied to a rind of said pineapple by a shower, a cascade andor by immersion of said pineapple.

18. The method according to claim 15, wherein said antimicrobial composition is applied to the peduncle of the harvested pineapple by brushing and/or spraying.

19. A pineapple comprising an antimicrobial composition according to claim 11.

20. A method for reducing weight loss of a crop optionally comprising a fruit, comprising treating said crop with a polyene fungicide, wherein said polyene fungicide optionally comprises natamycin.
